(19) United States
(12) Patent Application Publication
(10) Pub. No.: US 2014/0225392 A1
(43) Pub. Date: Aug. 14, 2014

(54) PLASTIC WRAP HANDLING TOOL

(71) Applicant: Roderick McLellan, Rockland, MA (US)

(72) Inventor: Roderick McLellan, Rockland, MA (US)

(21) Appl. No.: 14/054,324

(22) Filed: Oct. 15, 2013

Related U.S. Application Data
(60) Provisional application No. 61/850,249, filed on Feb. 12, 2013.

(51) Int. Cl. B25J 1/00

(52) U.S. Cl. CPC B25J 1/00
USPC 294/219

(57) ABSTRACT

A system for handling plastic wrap. The system includes a cling surface, where the cling surface is configured to be attracted toward or stick to the plastic wrap. The system also includes a handle. The handle is configured to allow a user to manipulate the position of the cling surface and has no attraction or adhesion to plastic wrap.

### CROSS-REFERENCE TO RELATED APPLICATIONS

This application claims the benefit of and priority to U.S. Provisional Patent Application Ser. No. 61/850,249 filed on Feb. 12, 2013, which application is incorporated herein by reference in its entirety.

### BACKGROUND OF THE INVENTION

Plastic wrap, cling film (UK), cling wrap or food wrap, is a thin plastic film typically used for sealing food items in containers to keep them fresh over a longer period of time. Plastic wrap, typically sold on rolls in boxes with a cutting edge, clings to many smooth surfaces and can thus remain tight over the opening of a container without adhesive or other devices. Common plastic wrap is roughly 0.5 mils, or 12.5 μm, thick.

In addition, large industrial size rolls of plastic wrap can be purchased. This plastic wrap is typically used to wrap large bundles of items. For example, pallets worth or cans can be wrapped in plastic wrap to ensure that the stack of cans remains substantially vertical, even when the pallet is moved.

All plastic wrap can be difficult to handle. In particular, plastic wrap sticks to itself which means if it is inadvertently folded, it becomes difficult to straighten. This is particularly true when the plastic wrap is being cut. The cutting process causes the plastic wrap to rebound from the cut causing folds that bring sections of plastic wrap in contact with one another. These sections then stick together making the fold permanent unless corrected by a user. Often if the plastic wrap becomes too folded it is simply thrown away and a new piece is used because straightening the plastic wrap becomes difficult in comparison to cutting a new piece for use.

Accordingly, there is a need in the art for a tool which allows for handling of plastic wrap. Further, there is a need in the art for the tool to be able to straighten plastic wrap if it is folded onto itself.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for handling plastic wrap. The system includes a cling surface, where the cling surface is configured to be attracted toward or stick to the plastic wrap. The system also includes a handle. The handle is configured to allow a user to manipulate the position of the cling surface and has no attraction or adhesion to plastic wrap.

Another example embodiment includes a system for handling plastic wrap. The system includes a cling surface, where the cling surface is configured to be attracted toward or stick to the plastic wrap. The system also includes a handle. The handle is configured to allow a user to manipulate the position of the cling surface and has no attraction or adhesion to plastic wrap. The system further includes a core, where the core attaches the handle to the cling surface.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a plastic wrap handling tool;

FIG. 2 is an end view of an alternative plastic wrap handling tool with a curved cling surface and handle;

FIG. 3 is a perspective view of an alternative plastic wrap handling tool in a cylindrical embodiment;

FIG. 4 is a front view of an alternative plastic wrap handling tool;

FIG. 5 is a perspective view showing an alternative plastic wrap handling tool with a rectangular handle and a flat section of cling surface;

FIG. 6 is an end view of an alternative plastic wrap handling tool; and

FIG. 7 is a perspective view of an alternative plastic wrap handling tool with an axially offset handle.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

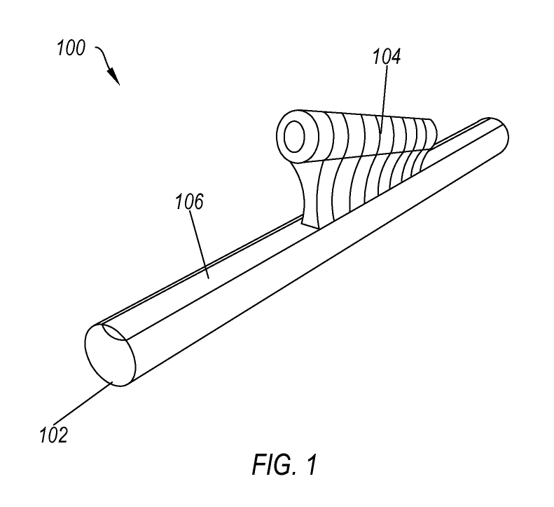

FIG. 1 illustrates an example of a plastic wrap handling tool 100. The plastic wrap handling tool 100 offers multiple advantages over a user using his/her hands or other objects. For example, the plastic wrap handling tool 100 is one piece and easy to use. Also, the plastic wrap handling tool 100 can be used with any dispenser including cardboard dispensers with exposed cutter blades and center adhesive tabs. Further, the plastic wrap handling tool 100 is configured to enable the transport of a piece of plastic wrap and maintain the wraps preferred rectangular shape. In addition, the plastic wrap handling tool 100 can be used to restore the shape of plastic wrap. I.e., the plastic wrap handling tool 100 can unwrinkle and unfold a crumpled piece of wrap, returning it to the preferred rectangular shape. Moreover, the plastic wrap handling tool 100 is economical. Not only is the plastic wrap handling tool 100 low cost but also less plastic wrap is wasted, saving money on wrap. Additionally, the plastic wrap handling tool 100 has a favorable environmental impact. Plastic wrap is conserved thereby lowering energy and resource requirements. Finally, the plastic wrap handling tool 100 aids in the pulling of plastic wrap from any dispenser, including cardboard box dispensers. In particular, the plastic wrap handling tool 100 provides for safety by keeping fingers further from exposed cutter blades.

FIG. 1 shows that the plastic wrap handling tool 100 can include a cling surface 102. The cling surface 102 is generally located on the bottom of the plastic wrap handling tool 100. The cling surface 102 can comprise the greater part of the plastic wrap handling tool's 100 outside area. The cling surface 102 can consist of any material which has a strong cling property toward plastic wrap, such as silicone rubber and certain plastics. The cling surface 102 is approximately the same length as the roll of plastic wrap which is to be manipulated. For example, typical rolls of plastic wrap are approximately 12 inches long; therefore, the cling surface 102 can be between 9.5 inches and 14.5 inches. The length of the cling surface 102 can be critical to ensure that the cling surface 102 can be used to handle cling wrap without excess effort. I.e., it is long enough to manipulate the cling wrap without being so long as to become unwieldy. As used in the specification and the claims, the term approximately shall mean that the value is within 10% of the stated value, unless otherwise specified.

For some plastic wraps, the main polymer is poly vinylidene chloride [PVdC] which has very high barrier properties against air and water vapor, which makes it commercially useful in the food packaging industry. In other plastic wraps, the main polymer is low density polyethylene [LDPE]. It is not as good a barrier as PVdC, but is much cheaper and is relatively easy to fabricate which makes it commercially viable as well.

Both PVdC and LDPE are relatively high molecular weight polymers which is needed to confer mechanical strength and barrier properties. Neither film, however, clings to itself. In order to make PVdC and LDPE cling to itself other LOW molecular weight polymers that aren't quite compatible with the host are added. The two most commonly used today are polyisobutylene and poly[ethylene-vinylacetate] or PIB and EVA, for short.

Unlike magnetism, in which like poles repel each other, in adhesive chemistry like materials attract each other. When the low molecular weight additives are put into a high molecular weight host of different composition, they tend to not mix (they form separate phases). When the film of PVdC or LDPE contacts itself, the PIB or EVA in the one film seeks out and associates with PIB or EVA in the second film surface. Since the additives are low in molecular weight, they are much more mobile than the host polymer. Higher mobility leads directly to the rapid development of an association that is perceived as ‘cling’.

FIG. 1 shows that the plastic wrap handling tool 100 can include a handle 104. The handle 104 of the plastic wrap handling tool 100 can be centrally located, axially offset and sized suitably for grasping between the thumb and fingers. One of skill in the art will appreciate that the handle 104 can be made of a material which has a weak or non-existent cling to plastic wrap to avoid having plastic wrap stick to the handle 104. For example, the handle 104 can be made of wood, plastic or other suitable material. In addition, the handle 104 can be ergonomically shaped to increase the comfort of the user during use.

FIG. 1 further shows that the plastic wrap handling tool 100 can include a core 106. The core 106 provides the framework to keep the cling surface 102 in the proper shape so that the cling surface 102 can be manipulated by a user. The core 106 may extend the entire length of the plastic wrap tool or it may extend far enough to properly support the cling surface 102 area. It consists of a material which is suitably light, strong and rigid. The core 106 can be suitably joined to the handle 104 or it can be integral to the handle 104. The core 106 can be substantially surrounded by the cling surface 102. I.e., a majority of the core 106 is covered by the cling surface. For example, the cling surface 102 can cover greater than 75% of the external surface of the core 106. The core 106 can be attached to the cling surface 102 using any desired method. For example, the core 106 can be attached to the cling surface using adhesive or any other attachment method.

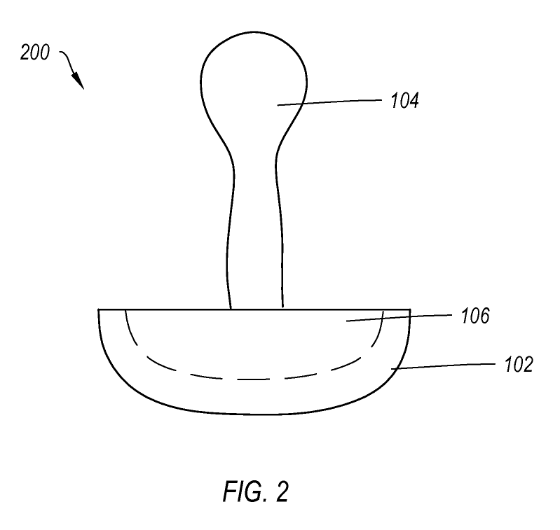

FIG. 2 is an end view of an alternative plastic wrap handling tool 200 with a curved cling surface 102 and handle 104. The plastic wrap handling tool 200 includes a core 106 embedded within the cling surface 102. I.e., the core is not visible externally but is completely surrounded by either the cling surface 102 or the handle 104.

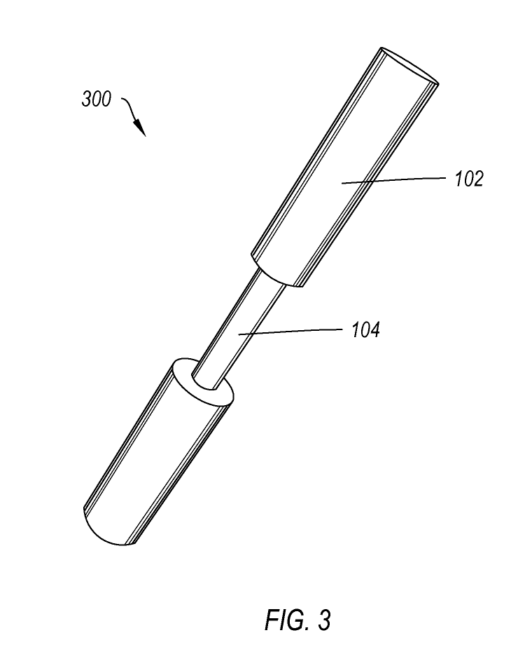

FIG. 3 is a perspective view of an alternative plastic wrap handling tool 300 in a cylindrical embodiment. The plastic wrap handling tool 300 is configured to be used with a guarded slide cutting dispenser with no adhesive tab in the center. I.e., the plastic wrap handling tool 300 cannot be used with an exposed blade or center adhesive tab because the fingers are too close to the blade and there is no center cling area to overcome the adhesive tab. Additionally or alternatively, the diameter of the handle 104 is less than the diameter or dimension of the two cling surface 102 sections.

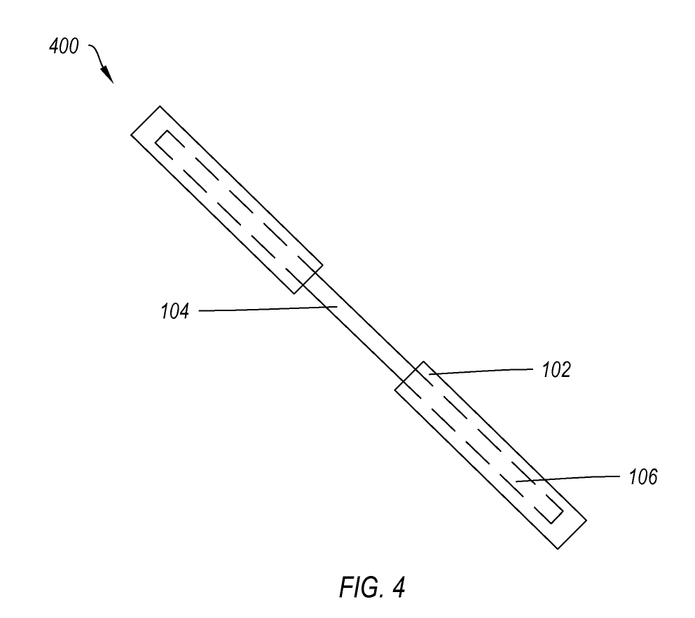

FIG. 4 is a front view of an alternative plastic wrap handling tool 400. The plastic wrap handling tool 400 includes a core 106 which extends from the handle 104 within the cling surface 102. I.e., the handle 104 connects two sections of cling surface 102 with embedded core 106. One of skill in the art will appreciate that the handle 104 can include an exposed section of core 106 or that the core 106 can include embedded sections of handle 104.

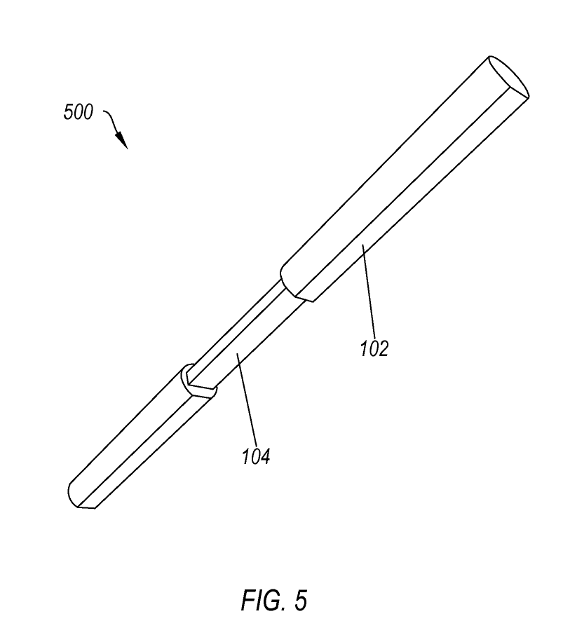

FIG. 5 is a perspective view showing an alternative plastic wrap handling tool 500 with a rectangular handle 104 and a flat section of cling surface 102. The core of the plastic wrap handling tool 500 can be embedded within the cling surface 102 similarly to the plastic wrap handling tool 400 of FIG. 4.

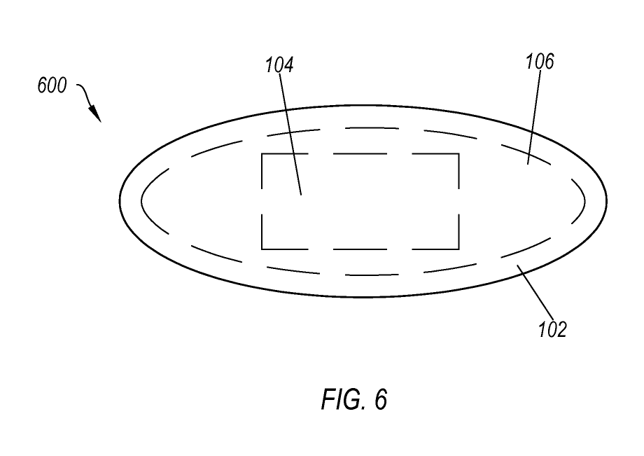

FIG. 6 is an end view of an alternative plastic wrap handling tool 600. FIG. 6 shows that the core 106 is embedded within the cling surface 102 similarly to the plastic wrap handling tool 400 of FIG. 4.

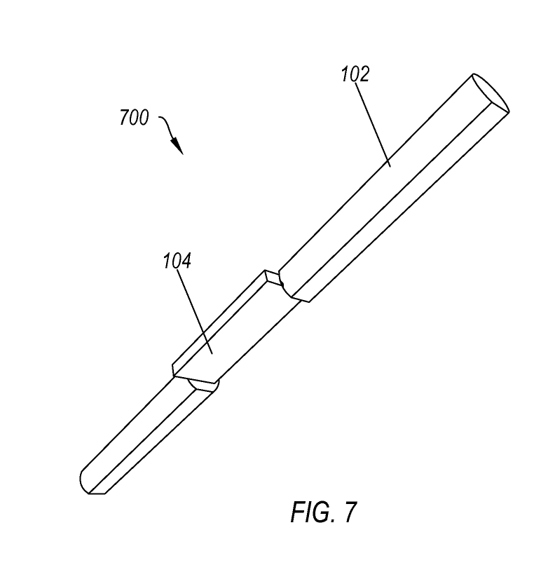

FIG. 7 is a perspective view of an alternative plastic wrap handling tool 700 with an axially offset handle 104. I.e., the axis of the cling surface 102 is not aligned with the axis of the handle 104

### Operation

The plastic wrap handling tool can be operated in three ways. It can be operated as a dispensing tool, a transport tool, or a shape restoration tool. Examples of use are provided below.

Hold the cardboard box dispenser in one hand or hold it down on an appropriate surface. With the other hand pick up the plastic wrap handling tool by its handle 104. Contact the exposed edge of the plastic wrap with the leading edge of the cling surface 102. Using the handle 104 roll the cling surface 102 toward the plastic wrap until sufficient surface contact is made between the plastic wrap and the cling surface 102 to create a temporary cling bond. Using the handle 104 pull the desired length of plastic wrap from the dispenser. Using the tool cut the plastic wrap along the dispenser cutting blade. The leading edge of the plastic wrap is held straight by the plastic wrap handling tool. The preferred rectangular shape of the dispensed plastic wrap is achieved. To release the friction/cling bond roll the tool off the end of the plastic wrap.

Secondly, it can be used to transport a rectangular piece of plastic wrap from one location to another. For this application two plastic wrap handling tools are required. With the rectangular piece of plastic wrap on an appropriate surface, hold one tool in each hand. Contact the leading end of the plastic wrap with the cling surface 102 of one tool and the following end with the cling surface 102 of the other tool. Roll both tools toward the center of the plastic wrap until a temporary cling bond is created. The rectangular piece of plastic wrap can be transported with its shape intact.

Thirdly, it can be used to restore a folded, wrinkled, or distorted piece of plastic wrap to its preferred rectangular shape. For this application two plastic wrap handling tools are required. With the folded, wrinkled, or distorted piece of plastic wrap on an appropriate surface, hold one tool in each hand by their respective] 2 handle 104s. Contact the best (most nearly straight) edge or end with the cling surface 102 of one tool and roll the tool sufficiently to create a temporary cling bond. Place the second tool next to the first tool on the wrinkled wrap. Roll the second tool away from the first tool while maintaining tension on the wrinkled wrap. Roll and pull the second tool away from the first tool several times until the plastic wrap is unwrinkled in that direction. Reposition the first tool to the best (most nearly straight) edge or end and repeat the process of unwrinkling the plastic wrap with the second tool. If the plastic wrap is folded under itself, disengage the second tool by rolling the tool off the edge of the wrap. Use the first tool to flip the wrap over and repeat the unwrinkling process to unfold the plastic wrap. Continue until the desired rectangular shape is achieved.

### Alternative Embodiments

The placement of the handle 104 can vary from axially centered to axially offset. The handle 104 can vary in configuration. An axially aligned handle 104 can be round, oval, square or any shape that operates well between the fingers. An axially offset handle 104 can be any shape that fits comfortably and operates well in the hand.

The placement of the handle 104 can vary from centered along its length to offset along its length. The placement of the handle 104 can be on the end of one long continuous cling surface 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for handling plastic wrap, the system comprising:
a cling surface, wherein the cling surface is configured to be attracted toward plastic wrap; and
a handle, wherein the handle:
is configured to allow a user to manipulate the position of the cling surface; and
has no attraction to plastic wrap.

2. The system of claim 1, wherein the cling surface includes silicone rubber.

3. The system of claim 1, wherein the cling surface includes plastic.

4. The system of claim 1, wherein the handle includes wood.

5. The system of claim 1, wherein the handle includes plastic.

6. The system of claim 1, wherein the longest axis of the cling surface is between 9.5 inches and 14.5 inches.

7. The system of claim 1, wherein the longest axis of the cling surface is approximately 12 inches.

8. A system for handling plastic wrap, the system comprising:
a cling surface, wherein the cling surface is configured to be attracted toward plastic wrap; and
a handle, wherein the handle:
is configured to allow a user to manipulate the position of the cling surface; and
has no attraction to plastic wrap; and
a core, wherein the core attaches the handle to the cling surface.

9. The system of claim 8, wherein the cling surface substantially surrounds the core.

10. The system of claim 8, wherein the cling surface covers more than 75 percent of the external surface of the core.

11. The system of claim 8, wherein the core is attached to the cling surface using adhesive.

12. The system of claim 8, wherein the longest axis of the core is shorter than the longest axis of the cling surface.

13. The system of claim 8, wherein the longest axis of the core is approximately the same length as the longest axis of the cling surface.
